(19) United States
(12) Patent Application Publication
(10) Pub. No.: US 2003/0022001 A1
(43) Pub. Date: Jan. 30, 2003

(54) Laminated glazing

(76) Inventors: Neil John Durbin, Birmingham (GB); Neil Barton, Merseyside (GB); Neil Winstanley, Merseyside (GB); Brian Edward Clieve, Lancashire (GB)

Correspondence Address: BURNS DOANE SWECKER & MATHIS L L P, POST OFFICE BOX 1404, ALEXANDRIA, VA, 22313-1404, US

(21) Appl. No.: 10/203,258

(22) PCT Filed: Feb. 15, 2001
(86) PCT No.: PCT/GB01/00617

(30) Foreign Application Priority Data
Feb. 18, 2000 (GB) 0003781.2

(51) Int. Cl. B32B 17/10

(52) U.S. Cl. 428/430

(57) ABSTRACT

A laminated glazing (20), suitable for automotive use, includes an infra-red reflecting film (26) bonded between a ply of ionomer resin (24) and a ply of a polymer material (28), wherein the polymer (28) material has a viscosity at the temperature and pressure required for lamination greater than that of the ionomer resin (24). Shrinkage of the infra-red reflecting film in reduced is comparison with a known similar glazing.

This invention relates to glazings and in particular to laminated glazings having a high intrusion resistance.

Glazings for automotive use comprise safety glass which may be laminated (widely used for windscreens) or toughened (widely used for sidelights and backlights). Both types of glazing provide some degree of impact resistance, with laminated glazings having certain advantages over toughened glass so that, although laminated glazings are more expensive to manufacture than toughened glass, it would be desirable for all automotive glazings to be laminated to give improved intrusion resistance and to improve occupant retention in collisions. However, while conventional laminated glass (using polyvinyl butyral interlayer) provides better intrusion resistance than toughened glass, it will not resist a sustained attack especially when (as in the case of opening side lights) it is not permanently secured around its periphery by the glazing system used.

The impact resistance of laminated glazings has been improved by incorporating an impact resistant ply in the laminate. WO 99/58334 discloses an impact resistant glazing which comprises an impact resistant ply of an ionomer resin which is laminated between two glass plies. Such a glazing has excellent properties of impact resistance and is suited to many applications including automotive use. However, it is desirable that automotive glazings are provided with properties of solar control to prevent ultra-violet radiation and infra-red radiation from entering the interior of the vehicle. Ultra-violet radiation may cause deterioration of fabric and furnishings found inside a vehicle and infra-red radiation may cause the temperature inside the vehicle to rise which may lead to discomfort for the occupants of the vehicle and put a load on air conditioning in the vehicle in order to reduce the temperature to an acceptable level.

WO 99/58334 discloses that colourants can be used in the ionomer resin or be added to the glass to control solar light. Such colourants may serve to absorb ultra-violet radiation and infra red radiation, however absorption of infra-red radiation leads to a build up of heat in the glazing itself which is not desirable in some glazings, particularly automotive glazings as the heat built up in the glazing may be radiated into the interior of the vehicle.

Laminated glazings which reflect infra-red radiation are known. The infra-red reflecting property of the glazing may be provided by a coating applied directly to the glass, however the capital cost required to provide such coatings on a mass produced scale can be prohibitive. A cheaper and satisfactory alternative which is widely used is the provision of an additional ply in the glazing of a transparent plastic film which reflects infra-red radiation, commonly polyethylene terephthalate (PET) carrying a thin layer or layers of reflective material, usually a metal (e.g. silver or silver/gold). The film transmits in the visible range of the electromagnetic spectrum and reflects in the infra-red range. The coated PET film does not adhere directly to glass and so in a glazing including such a film it is necessary to incorporate a layer that does adhere to glass between the film and the glass ply or plies of the glazing.

Attempts have been made to incorporate an infra-red reflecting PET film into a laminated glazing incorporating the ionomer resin disclosed in WO 99/58334. The film was bonded between two layers of the resin which in turn was bonded between two glass plies. However it was found that around the periphery of the glazing the PET film had shrunk causing optical distortion of the glazing around its periphery to the extent that it was not acceptable for automotive use.

In view of the aforementioned problems it is desirable to provide an impact resistant laminated glazing which reflects infra-red radiation and is acceptable for automotive use.

According to the present invention there is provided a laminated glazing including a film of substantially transparent flexible plastic which reflects infra-red radiation, bonded between a ply of ionomer resin and a ply of polymer material wherein at the temperature and pressure required for lamination the polymer material has a viscosity greater than that of the ionomer resin.

Glazings according to the invention have reduced optical distortion around their periphery and are suitable for general automotive use.

The polymer material may be thermoplastic which facilitates the production of curved laminates as it may be thermoformed to the required shape of the laminate during lamination. The polymer material may be polyvinyl butyral or polyurethane.

The infra-red reflecting film may comprise a film of polyethylene terephthalate (PET) and may have one or more thin layers of infra-red reflective material (e.g. metal) deposited thereon.

Preferably, the metal layer or layers is bonded to the ply of ionomer resin. Further preferably, metal coated PET has been edge sealed with ionomer resin during lamination.

The glazing may further include a first glass ply bonded to the ionomer resin and a second glass ply bonded to the polymer material. The glass plies will normally have a thickness of at least 0.7 mm and preferably at least 1.1 mm. In automotive laminates the outer glass ply usually has a thickness of about 1.5 mm or more to provide improved resistance to stone chipping. However, to avoid excessive weight and thickness it is generally desirable for automotive glazings to use glass plies of thickness not greater than about 3 mm.

The glass plies may be semi-toughened, i.e. the plies are toughened to lower toughening stresses than is usual for standard single ply toughened safety glass. In semi-toughened glass the number of fragments produced in a 5 cm×5 cm square in a fragmentation test will be less than 40 (the accepted standard for “fully” toughened glass). This is especially desirable when the laminate is to be used in an opening sidelight in a vehicle and is required to withstand slamming of the door with the window unsupported on at least one edge.

The ionomer resin ply may have a thickness of at least 0.3 mm to provide sufficient impact resistance. It is generally desirable to use an ionomer resin ply of 1.5 mm to 1.8 mm. The polymer material may have a thickness of at least 0.25 mm but the ready availability of such materials in greater thicknesses (e.g. 0.38 mm or 0.76 mm or more) may make it more convenient to use somewhat thicker layers.

An automotive glazing according to the invention may have a thickness of at least in the region of 3.5 mm. Furthermore, it is suitable for general automotive use, e.g. in mass-produced vehicles, and may be accommodated in conventional automotive glazing systems—i.e. the standard glazing channels which are less than about 6 mm (say 6 mm±0.5 mm) and may be about 5 mm (say 5 mm±0.5 mm) or about 4 mm (say 4 mm±0.5 mm). It is particularly advantageous that the vehicle bodywork need not be altered, so that glazings according to the invention may be offered as an option instead of standard glazing, or introduced partway through the life of a vehicle model.

The glazing may have an anti-spall layer applied to the glass ply arranged to face the interior of a vehicle which serves to prevent glass spall from the exposed inside face of the laminate when the glazing is subjected to an impact on its outer face, and hence protect occupants within the space enclosed by the glazing (typically the driver or passenger of a motor car) from injury as a result of being struck by or inhaling the glass spall.

An anti-lacerative layer may be applied to the glass ply which is arranged to face the interior of a vehicle to prevent occupants of the vehicle from being lacerated by broken pieces of glass when the glazing is subjected to an impact.

A low modulus interlayer may be applied to the inner side of the glass ply arranged to face the exterior of a vehicle to prevent cracks propagating from the glass ply to the other plies of the glazing.

Preferably the glazing includes a ply that absorbs ultra violet radiation.

The glazing is particularly suitable for any glazing of a vehicle, that is a windscreen, sidelight (fixed or opening) rearlight or rooflight.

An embodiment of the invention will now be described with reference to the accompanying drawings in which

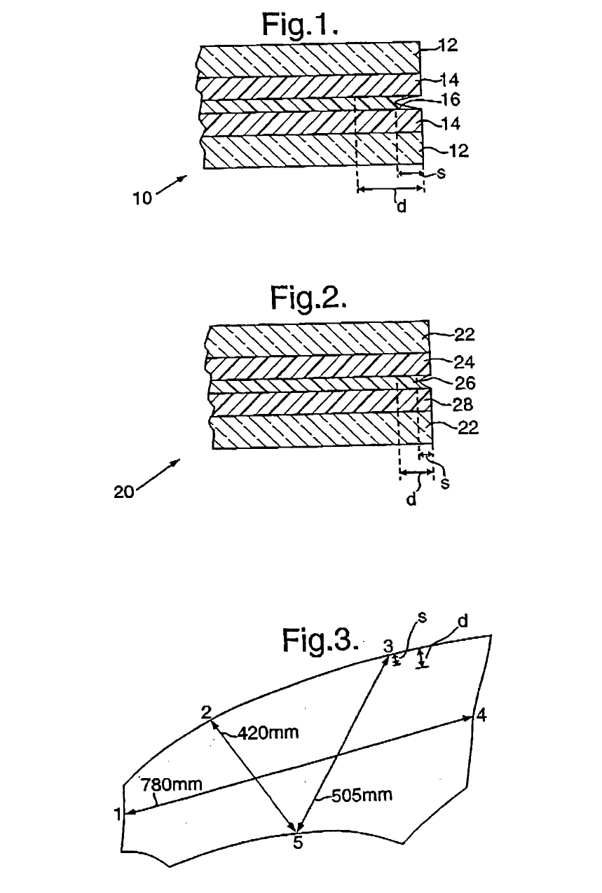

FIG. 1 is a fragmentary cross section of a known laminated glazing.

FIG. 2 is a fragmentary cross section of a laminated glazing in accordance with the invention.

FIG. 3 is a plan view of a laminated automotive glazing in accordance with the invention.

Referring to the drawings, FIG. 1 shows a glass laminate construction 10 comprising glass plies 12, plies of an ionomer resin 14 and an infra-red reflecting film 16. The ionomer resin is available under the trade name “Surlyn” from E.I. duPont de Nemours and Company. The infra-red reflecting film is of polyethylene terephthalate (PET) having a thin layer or layers of metal reflective material deposited thereon and is available from Southwall Technologies Inc under the trade name XIR 70.

In order that there is sufficient adhesion between the “Surlyn” resin and the glass, lamination is carried out at 145° C. and a pressure of 13 bar for a hold time of 40 minutes (hereinafter referred to as the “laminating conditions”). However, it is found that under these conditions the infra-red reflecting film 16 shrinks around the periphery of the glazing (by an amount shown as dimension s) which in turn leads to optical distortion (over a band having a width shown as dimension d) around the periphery of the glazing.

FIG. 2 shows a glass laminate construction 20 in accordance with the invention comprising glass plies 22, a ply 24 of “Surlyn” ionomer resin, a ply of polyvinyl butyral 28 and a film 26 of XIR 70. As with the glazing of FIG. 1, to ensure sufficient adhesion between the “Surlyn” resin and the glass, lamination of a glazing in accordance with the invention is carried out under the same laminating conditions as the glazing referred to with reference to FIG. 1. The metal layer of the XIR 70 film is bonded to the ply 24 of “Surlyn” ionomer resin. We found that the shrinkage of the infra-red reflecting film 26 and optical distortion of the glazing around the periphery of the glazing is markedly reduced in comparison with the glazing disclosed with reference to FIG. 1.

FIG. 3 shows the shape of a particular automotive glazing. A number of samples were constructed to this shape for comparison purposes with Samples 1A-4A being of the construction disclosed with reference to FIG. 1 with the glass plies being 2.1 mm thick and semi-toughened, the “Surlyn” plies being 0.76 mm thick and the XIR70 film being 50 μm thick. Samples B were of the construction disclosed with reference to FIG. 2 with the glass plies being 2.1 mm thick and semi-toughened, the “Surlyn” ply being 1.5 mm thick, the polyvinyl butyral ply being 0.38 mm thick and the XIR 70 film being 50 μm thick. Each sample was laminated under the aforementioned laminating conditions. Shrinkage and distortion were measured on each Sample at the points marked 1-5 on FIG. 3 and the results shown in Table 1 below. Both shrinkage (s) and optical distortion (d) were measured by eye in a direction perpendicular to the edge of the glazing at each measurement point (see FIG. 3) and were measured to the nearest 0.25 mm.

TABLE 1

| | Measuring Position and Shrinkage (s) and | | | | | | | | | | | |
|---|---|---|---|---|---|---|---|---|---|---|---|---|
| | Optical Distortion (d) values (mm) | | | | | | | | | | | |
| Sample | 1 | | 2 | | 3 | | 4 | | 5 | | Average | |
| No | s | d | s | d | s | d | s | d | s | d | s | D |
| 1A | 1.50 | 13.00 | 1.00 | 10.00 | 1.00 | 12.00 | 1.00 | 13.00 | 1.00 | 12.00 | 1.10 | 12.00 |
| 1B | 1.50 | 13.00 | 1.50 | 12.00 | 2.00 | 12.00 | 2.50 | 13.00 | 2.00 | 13.00 | 1.90 | 12.60 |
| 1C | 1.50 | 10.00 | 1.50 | 12.00 | 1.50 | 11.50 | 2.00 | 11.50 | 1.00 | 11.50 | 1.50 | 11.30 |
| 1D | 2.00 | 12.00 | 1.50 | 12.00 | 2.00 | 12.00 | 2.50 | 12.00 | 1.00 | 13.00 | 1.80 | 12.20 |
| | | | | | | | | | | | 1.575 | 12.025 |
| 2A | 0.75 | 8.00 | 1.00 | 8.00 | 1.00 | 8.50 | 1.50 | 7.50 | 0.75 | 8.00 | 1.00 | 8.00 |
| 2B | 0.50 | 7.50 | 0.50 | 7.50 | 0.50 | 8.00 | 1.00 | 7.00 | 0.50 | 8.50 | 0.60 | 7.70 |
| 2C | 1.00 | 8.50 | 1.50 | 7.50 | 0.50 | 8.00 | 2.00 | 9.00 | 1.00 | 7.00 | 1.20 | 8.00 |
| 2D | 0.50 | 8.50 | 0.25 | 7.50 | 0.25 | 8.50 | 1.50 | 8.00 | 1.00 | 8.50 | 0.70 | 8.20 |
| 2E | 0.75 | 7.50 | 1.00 | 8.00 | 0.50 | 7.00 | 1.50 | 8.00 | 1.50 | 7.00 | 1.05 | 7.50 |
| | | | | | | | | | | | 0.91 | 7.88 |

Using the average values generated in Table 1 Samples A have 73% more shrinkage and 53% more optical distortion than Samples B.

We believe the reason that the film of Samples B show less shrinkage and optical distortion than the film Samples A lies with the viscosity of the materials adjacent the film. We observed that under the aforementioned laminating conditions “Surlyn” has a lower viscosity than polyvinyl butyral (it was observed to flow more than polyvinyl butyral). The PET film has a tendency to shrink under the laminating conditions and the materials arranged on either side of the PET film provide resistance to it shrinking around the periphery of the glazing. However it appears that the more viscous polyvinyl butyral provides a greater resistance to shrinkage of the PET film than the “Surlyn”. This would seem to explain the results in Table 1 in which the Samples B, which include a ply of polyvinyl butyral and were found to be acceptable for automotive use, displayed somewhat reduced shrinkage and optical distortion compared with Samples A which were not acceptable for automotive use.

It will be appreciated that whilst the preferred embodiment discloses the use of polyvinyl butyral as the polymer layer having a viscosity at the temperature and pressure required for lamination greater than that of the ionomer resin, readily available alternatives, such as polyurethane, may be employed.

The laminated glazing of the invention may be manufactured with the metal layer coating of the XIR 70 film bonded to either the ply of “Surlyn” ionomer resin or the ply of polyvinylbutyral (PVB). However, in order to obtain enhanced durability performance of the laminated glazing it is preferred to have the metal layer bonded to the ply of “Surlyn” resin as per Samples B illustrated in FIG. 2 of the drawings.

Degradation (cracks) at the edge of the XIR 70 ply and corrosion of the laminate can be avoided by utilising the flow characteristics of the “Surlyn” ionomer resin to produce flow of the resin over the edge of the XIR 70 ply. The properties of the “Surlyn” resin and the PVB are different at the lamination temperature. The PVB shrinks slightly whereas the “Surlyn” resin melts with the result that the pressure during autoclave forces the “Surlyn” resin to move outwards and flow over the edge of the XIR 70 ply.

The above described edge sealing effect is useful for preventing degradation and corrosion of the laminate irrespective of whether the metal layer of the XIR 70 ply is positioned next to the “Surlyn” resin ply or to the PVB ply. Furthermore, the edge sealing is effective (a) when the laminated glazing of the invention is manufactured with the “Surlyn” resin ply, the PVB ply and the XIR 70 ply all cut to the same size or (b) when the laminate is manufactured with edge deletion of the XIR 70 ply (i.e. cut back from the edges of the “Surlyn” ply and the PVB ply)

It is to be noted that edge sealing of the XIR 70 ply with “Surlyn” resin does not disadvantageously affect the reduced shrinkage and reduced optical distortion obtained by the viscosity relationship between the “Surlyn” resin and the PVB.

Laminated glazings of the invention manufactured (a) with edge sealing and (b) with no edge sealing were subjected to two well known accelerated tests which are used to determine optimum laminate construction namely:

(i) Humidity Cycling—EC Regulation 43 entitled “Uniform Provisions Concerning the Approval of Safety Glazing and Glazing Materials—Resistance to Humidity Test”, and

(ii) Salt Spray Test—DIN50 021

The results of the tests showed that improved durability (i.e. reduced degradation and corrosion) was obtained when the laminated structure incorporated edge sealing of the XIR 70 ply with “Surlyn” resin.

It will also be appreciated that other known plies may be incorporated into a glazing in accordance with the invention. For example an anti-spall layer may be applied to the glass ply arranged to face the interior of a vehicle which serves to prevent glass spall from the exposed inside face of the laminate when the glazing is subjected to an impact on its outer face. thereby protecting occupants within the vehicle from injury.

It is also possible to apply an anti-lacerative layer to the glass ply arranged to face the interior of a vehicle to prevent occupants of the vehicle from being lacerated by broken pieces of glass when the glazing is subjected to an impact.

A laminate in accordance with the invention may display enhanced energy absorption and impact resistance if a ply of relatively low modulus interlayer material, preferably a thermoplastic material, is bonded to the inner side of the outer glass ply. Such a low modulus interlayer, having a tensile modulus of less than 100 MPa and preferably less than 10 MPa prevents cracks propagating through an outer glass ply into the other plies of the glazing. It is believed that such an interlayer does this by blunting the crack tip. A thin layer having a thickness of as little as 10 microns and ideally about 100 microns or more can be used for this purpose, although the ready availability of such materials in greater thicknesses (e.g. 0.38 mm thermoplastic polyurethane such as Morton PE399 available from Storens Urethane of Holyoke, Mass., USA or Tecoflex AG-89451 primerless film available from Lehmann & Voss & Co of Hamburg, Germany) may make it more convenient to use thicker layers.

It will further be appreciated that a glazing in accordance with the invention may include an ultra violet absorbing layer. For example polyvinyl butyral absorbs ultra violet radiation as does Tecoflex AG-8451.

1. A laminated glazing including a film of substantially transparent flexible plastic which reflects infra-red radiation bonded between a ply of ionomer resin and a ply of polymer material wherein at the temperature and pressure required for lamination the polymer material has a viscosity greater than that of the ionomer resin.

2. A laminated glazing as claimed in claim 1 wherein, the polymer material is thermoplastic.

3. A laminated glazing as claimed in claim 2 wherein the polymer material is polyvinyl butyral or polyurethane.

4. A laminated glazing as claimed in any preceding claim wherein the plastic film is polyethylene terephthalate.

5. A laminated glazing as claimed in any preceding claim wherein the film has one or more layers of infra-red reflective material deposited thereon.

6. A laminated glazing as claimed in claim 5 wherein the infra-red reflective material is one or more layers of a metal.

7. A laminated glazing as claimed in claim 6 wherein the metal layer or layers is bonded to the ply of ionomer resin.

8. A laminated glazing as claimed in any one of the preceding claims wherein the plastic film has been edge sealed with ionomer resin during lamination.

9. A laminated glazing as claimed in any preceding claim further including a first glass ply bonded to the ionomer resin and a second glass ply bonded to the polymer material.

10. A laminated automotive glazing as claimed in claim 9 wherein the glass plies each have a thickness of at least 1.5 mm.

11. A laminated automotive glazing as claimed in claim 9 or claim 10 wherein the glass plies have a thickness less than 3 mm.

12. A laminated automotive glazing as claimed in claim 10 or claim 11 wherein each glass ply is semi-toughened.

13. A laminated automotive glazing as claimed in any of claims 10 to 12 wherein the ionomer resin has a thickness of at least 0.3 mm.

14. A laminated automotive glazing as claimed in claim 13 wherein the ionomer resin has a thickness of 1.5 to 1.8 mm.

15. A laminated automotive glazing as claimed in any of claims 10 to 14 wherein the polymer material has a thickness of at least 0.25 mm.

16. A laminated automotive glazing as claimed in any of claims 10 to 15 having a thickness of at least in the region of 3.5 mm.

17. A laminated automotive glazing as claimed in any of claim 10 to 16 further including an anti-spall layer adhered to the glass ply which is arranged to face the interior of a vehicle.

18. A laminated automotive glazing as claimed in any of claims 10 to 17 further including an anti-lacerative layer adhered to the glass ply which is arranged to face the interior of a vehicle.

19. A laminated automotive glazing as claimed in any of claims 10 to 18 further including a low modulus interlayer adhered to the inner side of the glass ply arranged to face the exterior of a vehicle.

20. A laminated automotive glazing as claimed in any of claims 10 to 19 including a ply that absorbs ultra violet radiation.

21. A laminated automotive glazing as claimed in any of claims 10 to 20 being windscreen, fixed sidelight, rearlight or rooflight.

22. A laminated automotive glazing as claimed in any of claims 10 to 20 being an opening sidelight.
